(19) United States
(12) Patent Application Publication
(10) Pub. No.: US 2007/0147964 A1
(43) Pub. Date: Jun. 28, 2007

(54) Reamer

(75) Inventors: Rolf Cantz, Mistelgau (DE); Klaus Voigt, Immelborn (DE)

Correspondence Address: GREENBLUM & BERNSTEIN, P.L.C., 1950 ROLAND CLARKE PLACE, RESTON, VA, 20191, US

(73) Assignee: BOEHLERIT GmbH & Co. KG, Kapfenberg (AT)

(21) Appl. No.: 10/575,873

(22) PCT Filed: Oct. 18, 2004
(86) PCT No.: PCT/AT04/00356

§ 371 Date: Oct. 16, 2006

(30) Foreign Application Priority Data
Oct. 16, 2003 (AT) A 1633/2003

(51) Int. Cl. B26D 1/12

(52) U.S. Cl. 407/35

(57) ABSTRACT

The invention relates to a reamer R comprising a base body (1) with a cutting element (2) and at least one guiding strip (3) aligned essentially axially with an abutment surface (31) and a guiding surface (32), whereby the guiding strip (3) is connected to the base body (1) in the area of the abutment surface (31). In order to be able to work different materials with a single reamer R over a long period of use of the reamer R, it is proposed according to the invention that the guiding strip (3) is formed of layered bodies (41, 42) with different materials running from the guiding surface (32) to the abutment surface (31).

The invention relates to a reamer according to the preamble to claim 1

Reamers of this type have become known from EP 0558 811 81, DE 43 29 553 C1 and DE 197 46 462 C1 and are used to produce precision-fitting bores with smoothed bore surface. They each have a base body that, in addition to a cutting element that is effective in machining terms and that is attached to the front, supports at least one guiding strip that extends with its longitudinal axis parallel to a rotational axis of the base body.

With regard to the surface quality and bore precision as well as the period of use of such reamers, a guiding strip is of particularly great importance. During a boring process, a guiding strip supports the base body in the bore and in this manner relieves a cutting element in terms of forces, which cutting element through the rotation of the base body and with a feed motion relative to a workpiece produces a chip removal on the same. During a rotational movement of the base body, the one guiding strip holds or, if necessary, several guiding strips hold thereby the cutting element relative to the worked workpiece on a desired travel circle, thus contributing to an exact guidance of the cutting element and to a high bore precision. At the same time the bore surface is effectively smoothed during the creation of a bore by friction with a guiding strip. It can therefore be said that a guiding strip performs smoothing and guiding functions.

A faultless performance of the above-mentioned functions of a guiding strip is also desirable in the case of a continuous use of reamers, as is frequently customary, e.g., in automobile production. In order to achieve the longest possible period of use of reamers under great stresses, special measures in working a workpiece or a use of alternative guiding strips were hitherto proposed.

With regard to special measures in working a workpiece with reamers, it is known to use cooling lubricants through which when using a reamer its guiding strips are to be kept at the lowest possible temperature in order to avoid welding onto the guiding strips chips removed or parts thereof. However, one problem is that cooling lubricants are difficult to insert into an area between the guiding surface of a guiding strip and a workpiece; it is often impossible to achieve a cooling effect to the necessary extent.

With regard to a use of alternative guiding strips, it has been proposed to provide guiding strips usually made of hard metal in addition with a coating, e.g., of diamond (EP 0 558 811 B1). The type of coating is thereby based on the material to be worked, which is why reamers with guiding strips with different coatings are used for working different materials. For example, according to DE 43 29 553 A1, reamers with guiding strips of hard metal which are coated with cubic boron nitride are to be used for working hardened steel alloys, whereas for working aluminum materials, diamond-coated guiding strips are considered suitable instead.

Another disadvantage of reamers with coated guiding strips is that the coatings have low strengths or thicknesses of only a few micrometers. A coating is therefore soon worn out with the use of a reamer. Best smoothing and guiding functions of a guiding strip and a high bore quality associated therewith can then no longer be guaranteed. Moreover, with a rotary motion of the reamer strong tangential forces occur during use which attack the coated guiding strips and essentially act in the direction of the hard metal/coating interface, which can cause the coating to flake off.

The latter factors in particular mean that with regard to working different materials not only are individual reamers necessary but also their practical period of use in working a single material is often inadequate.

The object of the invention is to disclose a reamer of the type mentioned at the outset, which reamer is suitable for processing different materials and has a long period of use.

This object is attained through a reamer according to claim 1.

The advantages obtained with the invention are to be seen in particular in that a reamer according to the invention is suitable for working workpieces of different materials. A composite construction of a guiding strip and a course according to the invention of layered bodies results in a flat guiding surface that is composed of different materials. Each of these materials is particularly suitable for working a certain material, and a reamer according to the invention can be used in a correspondingly versatile manner. Since the layered bodies extend from an abutment surface to a guiding surface or vice versa, in addition the material areas effective for a smoothing of a bore surface are always available even with long-term use and wear possibly present in the area of the guiding surface. A smoothing function can thus be ensured long-term.

If a workpiece is worked with a reamer according to the invention, that part of the layered bodies of the material with the greatest wear resistance with respect to the material worked performs a smoothing of a bore surface. The remaining part of the layered bodies which is made of other materials consequently has a lower wear resistance with respect to the material worked and this part is preferably worn on the guiding surface side. Another important advantage is revealed here, for channels or troughs as it were are formed on a guiding surface through this different wear behavior, in which channels or troughs coolants can reach in an advantageously simple manner the most stressed contact surfaces between smoothing-active areas of the guiding strip and worked workpiece.

In a preferred embodiment of the invention the layered bodies run essentially parallel to the rotational axis of the base body. In this embodiment, one sequence of layered bodies of different materials is given over the entire length of a guiding strip, and bore surfaces can be smoothed with high quality over the entire length of the guiding strip. An effective cooling and, if necessary, lubrication can also be achieved over the entire length of a guiding strip.

A particularly advantageous embodiment of a reamer according to the invention is when the layered bodies run essentially perpendicular to the rotational direction of the base body. A tangential frictional force thus acts vertically on the layered bodies of the guiding strip during use of the reamer. Not only can a reciprocal detachment of the same or peeling off of individual layered bodies be completely avoided, but the individual layered bodies are pressed together by a tangential force

It has proven to be particularly favorable when the guiding strip has layered bodies of hard metal and layered bodies of diamond or cubic boron nitride. In this case both softer metals such as aluminum and harder metals such as hardened steel alloys can be advantageously worked with a reamer. In working softer materials, a diamond layered body causes a smoothing of a bore and a guiding of the reamer, whereas a hard metal layered body supports the smoothing-active diamond layer. It is also important that a cooling lubricant channel is formed on the free surface of the hard metal layered body/bodies in the area of the guiding surface. If harder materials such as steels are worked, it is the other way around: hard metal layered bodies cause a smoothing and diamond layered bodies perform a support function or cooling lubricant channels are formed in the guiding surface area of the same.

Within the scope of more extensive tests, it has proven to be advantageous for working different materials if a guiding strip comprises layered bodies of hard metal with a thickness of 1000 μm to 1500 μm. Thicknesses of at least 1000 μm prove to be favorable with respect to a smoothing when working steel. Thicknesses greater than 1500 μm can result in a quicker wear of the guiding strip when working workpieces of aluminum alloys or in a shorter period of use of the reamer.

In the tests mentioned above, it also proved to be advantageous if the guiding strip comprises layered bodies of diamond or cubic boron nitride with a thickness of 2 μm to 500 μm, in particular 10 μm to 50 μm, because then both aluminum alloys and steel alloys can be worked with favorable wear behavior of a guiding strip and long period of use of the reamer.

It is advantageous if at least one layered body is made of hard metal and is connected to a layered body of diamond, because a direct connection of layered bodies of hard metal and layered bodies of diamond has a favorable impact on the durability of the composite structure or the durability of the layered body bond of the guiding strip. It has proven to be particularly expedient in this connection if the layered body of diamond is produced by deposition of diamond on the layered body of hard metal. In this manner a direct connection of smoothing-active layered bodies can be achieved by adhesive force, which connection can withstand particularly high stresses, rendering it possible to provide reamers with a particularly long period of use.

Such an embodiment variant of a reamer is simple to produce. It is necessary merely to coat with diamond on both sides hard metal layered bodies with dimensions according to a guiding strip to be produced, thus producing individual components. Subsequently, the coated individual components can be connected to one another in the areas of the free surfaces of the diamond coatings, whereby preferably a first solder mass is used.

Specifically, a solder mass has proven useful for this which contains copper and silver as main constituents and titanium and/or yttrium as further elements. In a connection of diamond layered bodies by a solder mass, this ultimately also forms a layered body which should preferably have a thickness of 10 μm to 25 μm. A bond of diamond layers or a connecting effect by the solder mass can be impaired with thicknesses less than 10 μm. Thicknesses greater than 25 μm should be avoided because the metallic solder mass is heated with a reamer use and thus an increased cooling is necessary. Thicknesses greater than 25 μm do not have a positive effect on a bond of diamond layers either.

An attachment of the guiding strip to the base body is expediently made by a second solder mass which has a lower melting point than a first solder mass.

In the event of a wear of a guiding strip, a quick replacement of the same can be achieved in particular when it is connected to be base body by an adhesive mass.

The invention is described in more detail below on the basis of exemplary figures.

They show:

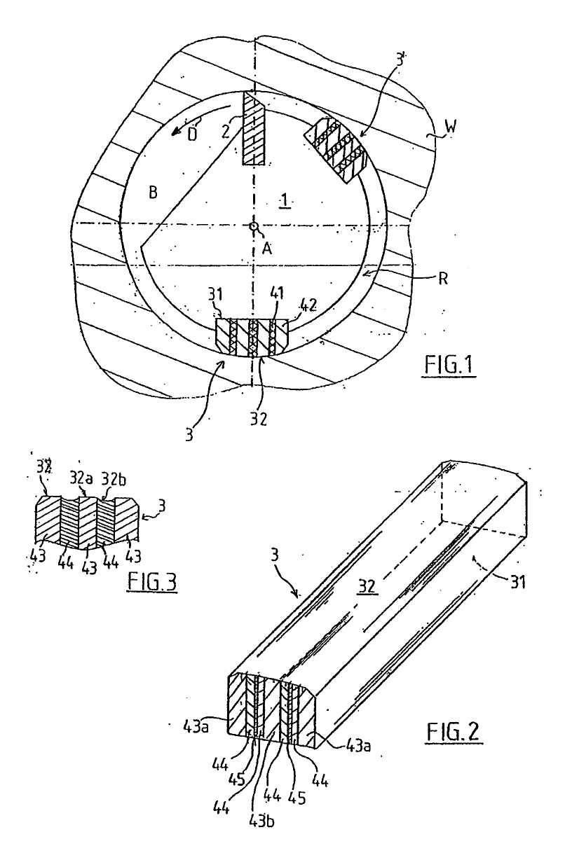

FIG. 1 A diagrammatic representation of a cross section through a reamer according to the invention, the cross section running perpendicular to the rotational axis,

FIG. 2 A guiding strip,

FIG. 3 A cross section through a guiding strip after one use.

FIG. 1 shows a diagrammatic cross section through a front area of a reamer R according to the invention. A base body 1 with an axis A supports a cutting element 2 which is soldered or adhered to the base body 1 or can be attached in another manner, e.g., by means of a clamping screw. Furthermore, two guiding strips 3, 3′ are attached to the base body 1, which guiding strips extend parallel to axis A with respect to their longitudinal axes and are positively accepted by shaped seats of the base body 1 Guiding strips 3, 3′ can be connected to the base body 1 by adhesive force with an adhesive or solder mass.

The guiding strips 3, 3′ are placed after the cutting element 2 in the rotational direction D at angles of approx. 45° or 180° and comprise respectively layered bodies 41, 42 connected to one another in a flat manner and running from an abutment surface 31 to a guiding surface 32. Furthermore, the individual layered bodies 41, 42 have a course parallel to axis A and to the rotational direction D of the base body 1.

A reamer R shown in FIG. 1 with layered bodies 41, 42 of the guiding strips 3 running accordingly is characterized by a particularly high resistance to acting tangential forces. Whereas with coated guiding strips the coating can be detached with a rotational movement in the bore B in the direction D due to the forces thus acting parallel to a guiding surface, the guiding strips 3, 3′ of reamers according to the invention can now easily absorb these forces due to a perpendicular position of the layered bodies 41, 42.

FIG. 2 shows an embodiment of the guiding strip 3 of a reamer according to the invention in greater detail. The guiding strip 3 comprises a plurality of layered bodies 43, 44, 45 lying parallel to one another, which layered bodies run from an abutment surface 31 towards a guiding surface 32 and extend over the entire length of the guiding strip 3.

A guiding strip 3 that is particularly easy to produce and is shown in FIG. 2 can be such that a layered body 43a of hard metal forming a first lateral surface is connected over the whole area to a layered body 44 of diamond. This is connected to a sequence of layered bodies 45, 44, 43b, 44, 45 or in the order of the corresponding materials solder mass diamond—hard metal—diamond—solder mass. Such a layered body series can be provided once or several times as required. Finally a layered body 44 of diamond and a layered body 43a of hard metal forming the second lateral surface follow again towards the second lateral surface.

A production of a guiding strip shown in FIG. 2 can be carried out simply in that individual layered bodies 43a and 43b, respectively formed of hard metal are provided with dimensions that correspond to the guiding strip to be produced. Subsequently layered bodies 43a are coated with diamond on one side and layered bodies 43b are coated with diamond on both sides. The components thus produced are then assembled to form a guiding strip 3 by connecting the layered bodies 44 of diamond with a solder mass by adhesive force and forming layered bodies 45 of solder mass.

FIG. 3 shows a shaping of a guiding surface 32 with wear of a first part of layered bodies 44, made of, e.g., hard metal, and layered bodies 43 not worn and made of, e.g., diamond. The guiding surface 32 shows on the one hand in the area of the layered bodies 43 idealized flat areas 32a through which surface areas 32a during use a smoothing of a bore surface and a guiding of the reamer R in a bore are caused. In the area of layered bodies 44, which comprise hard metal wearing more quickly when working aluminum, arched areas 32b are present, so that channels or troughs are formed in which cooling lubricant can be transported to smoothing-active flat areas 32a.

A shaping of a guiding surface shown in FIG. 3 could be observed in working workpieces of aluminum. If a guiding strip 3 in a condition as shown in FIG. 3 is used for working workpieces of steel, an essentially flat guiding surface 32a is reached again as it were through wear in a self-grinding manner. Consequently in a reversal of the effect observed in working aluminum, guiding surface areas of hard metal take on a smoothing of the bore and guiding of the reamer and a cooling lubricant transport can occur in the area of the diamond layered bodies.

1- Reamer comprising a base body with a cutting element and at least one guiding strip aligned essentially axially with an abutment surface and a guiding surface, whereby the guiding surface is connected to the base body in the area of the abutment surface, characterized in that the guiding strip is formed of layered bodies of different materials running from the guiding surface to the abutment surface.

2- Reamer according to claim 1, characterized in that the layered bodies run essentially parallel to the rotational axis of the base body.

3- Reamer according to claim 1, characterized in that the layered bodies run essentially perpendicular to the rotational direction of the base body.

4- Reamer according to claim 1, characterized in that the guiding strip has layered bodies of hard metal and layered bodies of diamond or cubic boron nitride.

5- Reamer according to claim 1, characterized in that the guiding strip comprises layered bodies of hard metal with a thickness of 1000 μm to 1500 μm.

6- Reamer according to claim 1, characterized in that the guiding strip comprises layered bodies of diamond or cubic boron nitride with a thickness of 2 μm to 500 μm, in particular 10 μm to 50 μm.

7- Reamer according to claim 1, characterized in that at least one layered body is made of hard metal and is connected to a layered body of diamond.

8- Reamer according to claim 7, characterized in that the layered body of diamond is made through deposition of diamond on the layered body of hard metal.

9- Reamer according to claim 7, characterized in that the guiding strip has layered bodies of diamond which are connected with a first solder mass.

10- Reamer according to claim 9, characterized in that the first solder mass contains copper and silver as main constituents and titanium and/or yttrium as further elements.

11- Reamer according to claim 9, characterized in that the layered body/bodies formed through the first solder mass has/have a thickness of 10 ÿm to 25 ÿm.

12- Reamer according to claim 9, characterized in that the guiding strip is connected to the base body by a second solder mass which has a lower melting point than a first solder mass.

13- Reamer according to claim 1, characterized in that the guiding strip is connected to the base body by an adhesive mass.
